(19) United States
(12) Patent Application Publication
(10) Pub. No.: US 2026/0141607 A1
(43) Pub. Date: May 21, 2026

(54) FACTORIZED MOTION COMPLETION FOR PRECISE AND CHARACTER-AGNOSTIC MOTION DIFFUSION

(71) Applicants: DISNEY ENTERPRISES, INC., Burbank, CA (US); ETH Zürich (Eidgenössische Technische Hochschule Zürich), Zürich (CH)

(72) Inventors: Jakob Joachim BUHMANN, Zürich (CH); Justin Thierry STUDER, Grafenried (CH); Dominik Tobias BORER, Greifensee (CH); Dhruv AGRAWAL, Zürich (CH); Martin GUAY, Unterengstringen (CH); Robert Walker SUMNER, Zürich (CH)

(21) Appl. No.: 18/954,335

(22) Filed: Nov. 20, 2024

(51) Int. Cl. G06T 13/40

(52) U.S. Cl. CPC G06T 13/40; G06T 2200/04

(57) ABSTRACT

The present invention sets forth techniques for animating a three-dimensional (3D) character model. The disclosed techniques include receiving one or more spatial constraints associated with a first set of one or more reference points included in a first 3D character model, and generating, via a first machine learning model and based on the one or more spatial constraints, a set of trajectories associated with each reference point included in the first set of one or more reference points. The techniques also include generating, via a second machine learning model and based on the set of trajectories, a set of framewise positions associated with a second set of one or more reference points included in a second 3D character model. The techniques further include generating an output animation depicting motion of the second 3D character model based on the set of framewise positions.

### BACKGROUND

### Field of the Various Embodiments

Embodiments of the present disclosure relate generally to computer animation and, more specifically, to techniques for animating a three-dimensional (3D) character via diffusion models.

### Description of the Related Art

Animating a 3D character model including one or more bones, joints, or other reference points is a common task in the field of computer animation. While 3D character motion may be modeled via explicitly defining the positions over time of one or more joints, bones, or reference points included in the 3D character model, these manual animation techniques are cumbersome and time-consuming. Neural motion completion techniques attempt to at least partially automate 3D character animation by predicting a sequence of character motions based on a starting position, previous motions, and/or one or more conditioning inputs.

Existing techniques for automating 3D character animation may include one or more motion diffusion models. These generative machine learning models attempt to produce realistic 3D character model movements, and may be conditioned on, ec, text inputs or sample movements. One drawback to these existing systems is that the existing motion diffusion models may be trained on a specific 3D character model, and may not be suitable for use with a different 3D character model. Further, existing motion diffusion models may not be operable to infer an animation sequence that is conditioned on a relatively small set of sparsely distributed constraints compared to a much larger set of motion representation data used to condition the motion diffusion model, and may produce unacceptable deviations from the specified constraints at one or more time points included in the inferred animation sequence. While existing motion diffusion models may be operable to accurately infer an animation sequence that is conditioned on a relatively larger set of densely distributed constraints, such inference is computationally expensive, and may not be suitable for generating or modifying animation sequences interactively in real time or near-real time. Existing motion diffusion models may also lack compatibility with traditional authoring tools. This incompatibility may complicate animation workflows, as traditional authoring tools may not be suitable for making even minor adjustments or corrections to inferred animation sequences.

As the foregoing illustrates, what is needed in the art are more effective techniques for animating 3D characters via diffusion models.

### SUMMARY

One embodiment of the present inventions sets forth a technique for animating a 3D character model. The technique includes receiving one or more spatial constraints associated with a first set of one or more reference points included in a first 3D character model, and generating, via a first machine learning model and based on the one or more spatial constraints, a set of trajectories associated with each reference point included in the first set of one or more reference points. The technique also includes generating, via a second machine learning model and based on the set of trajectories, a set of framewise positions associated with a second set of one or more reference points included in a second 3D character model and generating an output animation depicting motion of the second 3D character model based on the set of framewise positions.

One technical advantage of the disclosed techniques relative to the prior art is that the disclosed techniques infer motion sequences for a specific 3D character model via both a character-agnostic 3D motion model and a character-specific 3D character model. The character-agnostic motion model includes a limited number of bones, joints, or other reference points, and may be trained on a relatively large quantity of motion sequences captured from a variety of different 3D animation characters. The character-specific character model, in contrast, requires a relatively small amount of character-specific training data. The use of both character-agnostic and character-specific models allows the disclosed techniques to generate motion sequences for a variety of character-specific 3D character models, including 3D character models for which only a limited amount of training data is available. The disclosed techniques also infer character movements over time by expressing the motion of joints or other reference points as Bézier curves. Bézier curves are compatible with traditional 3D animation authoring tools, and allow for simple corrections to reference point positions in an inferred motion sequence. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a more detailed illustration of the training engine of FIG. 1, according to some embodiments.

FIG. 3 is a more detailed illustration of the Bézier Motion Model of FIG. 2, according to some embodiments.

FIG. 4 is a flow diagram of method steps for training a motion model, according to some embodiments.

FIG. 5 is a more detailed illustration of the inference engine of FIG. 1, according to some embodiments.

FIG. 6 is a flow diagram of method steps for inferring 3D character model motion, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

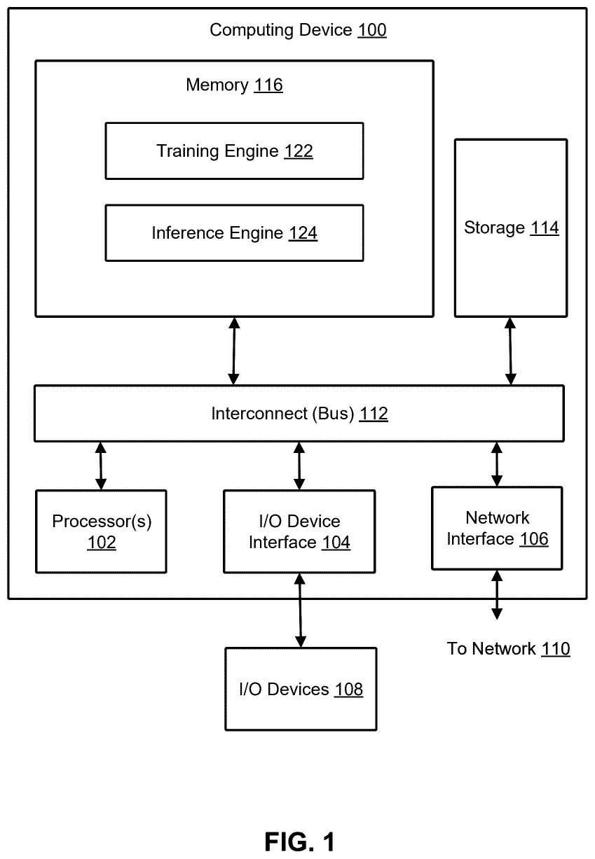

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an inference engine 124 that reside in a memory 116.

It is noted that the computing device described herein is illustrative and that any other technically feasible configurations fall within the scope of the present disclosure. For example, multiple instances of training engine 122 or inference engine 124 could execute on a set of nodes in a distributed and/or cloud computing system to implement the functionality of computing device 100. In another example, training engine 122 or inference engine 124 could execute on various sets of hardware, types of devices, or environments to adapt training engine 122 or inference engine 124 to different use cases or applications. In a third example, training engine 122 or inference engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and inference engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 or inference engine 124.

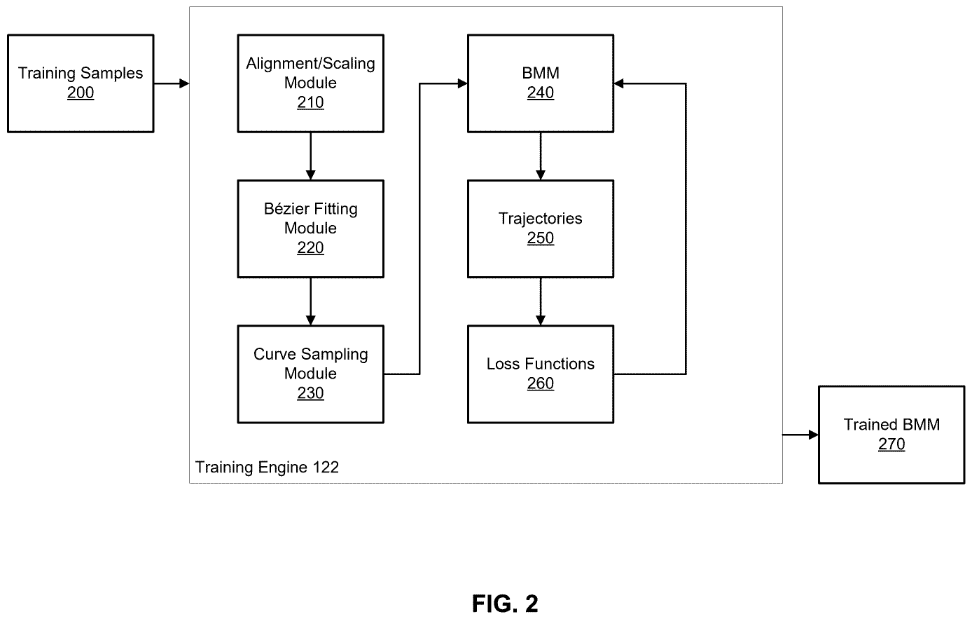

FIG. 2 is a more detailed illustration of training engine 122 of FIG. 1, according to some embodiments. Training engine 122 modifies one or more values associated with a generative Bézier Motion Model (BMM) 240 based on one or more training samples 200 to generate a trained BMM 270. Trained BMM 270 generates Bézier control points associated with one or more reference points included in a generic 3D character model, given one or more spatial constraints associated with the one or more reference points. Bézier control points may include one or more locations in a 3D coordinate system defining locations through which a generated Bézier curve must pass. Bézier control points may also include one or more tangents, where each tangent describes the shape of the generated Bézier curve at a location in the 3D coordinate system. Training engine 122 includes, without limitation, alignment/scaling module 210, Bézier fitting module 220, curve sampling module 230, BMM 240, trajectories 250, and one or more loss functions 260.

In various embodiments, training samples 200 include one or more animation sequences, where each animation sequence includes multiple frames depicting one of multiple character-specific 3D character models. Each of the multiple character-specific 3D character models may include an arbitrary number of reference points associated with features of the 3D character model, such as bones or joints. In various embodiments, each of the multiple character-specific 3D character models may exhibit a generally humanoid appearance, such that the character-specific 3D character model includes reference points substantially corresponding to at least a head, left and right hands, left and right feet, and hips included in a 3D character. In some embodiments, a single reference point representing both hips included in the 3D character may be located substantially at the geometric center of the 3D character's pelvis.

Each of multiple frames included in an animation sequence depicts 3D positions and/or orientations of multiple reference points associated with the 3D character model. Each of the multiple frames also includes a sequential frame number, such that the multiple frames, when viewed in an order specified by the sequential frame numbers, depict motion of the 3D character model over time.

Alignment/scaling module 210 adjusts the shape and size of a character-specific 3D character model included in training samples 200 to align the character-specific 3D character model to a generic 3D character model. In various embodiments, the generic 3D character model may include a limited subset J_{sub} of reference points representing bones, joints, or other features of the generic 3D character. For example, the generic 3D character model may include six reference points representing a head, left hand, right hand, left foot, right foot, and a single hip reference point. Alignment/scaling module 210 may scale or otherwise transform a character-specific 3D character model included in one of training samples 200, such that positions of reference points included in the training sample corresponding to the limited subset J_{sub} of reference points align (or substantially align) with the positions of the limited subset J_{sub} of reference points included in the generic 3D character model. For each frame of an animation sequence included in training samples 200, alignment/scaling module 210 generates a corresponding frame depicting the generic 3D character model, where the positions and/or orientations of the limited subset J_{sub} of reference points included in the generic 3D character model are based on the positions and/or orientations of corresponding reference points included in the character-specific 3D character model.

In various embodiments, alignment/scaling module 210 may discard reference points included in the character-specific 3D character model that do not correspond to the limited subset J_{sub} of reference points included in the generic 3D character model. Alignment/scaling module 210 may also translate the generated generic 3D character model to a predetermined location within a 3D coordinate system. For example, in each generated frame included the generic 3D character model, alignment/scaling module 210 may translate the generic 3D character model such that the reference point representing the generic 3D character's hips is located at the origin of a 3D coordinate system.

Alignment/scaling module 210 may also identify one or more keyframes associated with a generic 3D character model animation sequence generated by alignment/scaling module 210. In various embodiments, alignment/scaling module 210 may designate every Nth frame of an animation sequence as a keyframe, where N is equal to, e.g., six. For each designated keyframe, alignment/scaling module 210 records the positions and orientations of each of the limited subset J_{sub} of reference points included in the generic 3D character model and depicted in the frame. Training engine 122 transmits these recorded positions and orientations to BMM 240 described below as ground truth constraints while training BMM 240. Alignment/scaling module 210 transmits the generated generic 3D character model animation sequence, the keyframe designations, and the recorded keyframe positions and/or orientations to Bézier fitting module 220.

Bézier fitting module 220 generates, for each reference point included in the limited set of reference points, a Bézier curve describing the motion of the reference point beginning at one keyframe and ending at the subsequent keyframe. A Bézier curve includes a parametric function that is operable to perform smooth interpolation between two points based on an approximation of a continuous function. A Bézier curve of degree n is defined by:

$$B ( t ) = {\sum }_{i = 0}^{n} ( \begin{matrix}n \\ i\end{matrix} ) {( 1 - t )}^{n - i} {t}^{i} {P}_{i} , 0 \leq t \leq 1 , \qquad ( 1 )$$

where

$${\{ {P}_{i} \}}_{i = 0}^{n}$$

is a set of control points, and 0≤t≤1 represents a position along the Bézier curve.

In various embodiments, each of the Bézier curves may include a cubic Bézier curve (i.e. a curve having a degree n=3) defined by four points. Equivalently, a cubic Bézier curve may be defined by a starting point, an ending point, and tangents associated with each of the starting and ending points. For a portion of a received generic 3D character animation sequence including at least two keyframes, Bézier fitting module 220 generates a cubic Bézier curve for each reference point included in the animation sequence, where the cubic Bézier curve describes the motion and orientation of the reference point in the 3D coordinate system from the starting keyframe to the subsequent engine keyframe. Bézier fitting module 220 may continue generating additional cubic Bézier curves associated with each reference point, taking the most recent ending keyframe as a new starting keyframe and selecting a subsequent keyframe in the animation sequence as a new ending keyframe. Bézier fitting module 220 may continue processing the received generic 3D character animation sequence until Bézier fitting module 220 has generated cubic Bézier curves describing the motion of each of the limited subset J_{sub} of reference points throughout the animation sequence. Bézier fitting module 220 transmits the generated Bézier curves to curve sampling module 230.

Curve sampling module 230 samples, via Equation (1) above, the generated Bézier curves at multiple points included in the curves to generate dense trajectories in a 3D coordinate system associated with each reference point included in the limited subset J_{sub} of reference points. In various embodiments, the dense trajectory for a reference point may include an associated position and an associated orientation for the reference point at each frame included in a window, where the window includes animation frames located between a starting keyframe and an ending keyframe.

For each reference point j∈J_{sub}, curve sampling module 230 defines its 3D position at frame i as

$${P}_{j}^{i} .$$

Its dense position trajectory, Pⱼ, is then given by

$${P}_{j}^{i}$$

for i∈1, . . . , N, where N is the window length. Curve sampling module 230 stacks all position trajectories as P=[Pⱼ|j∈J_{sub}]. Curve sampling module 230 similarly defines the tangents T, such that P and T define the full set of Bézier curves. Lastly, orientations 0 for each frame i are represented as vectors, where the dimensionality of the vector is equal to the number of reference points included in the limited subset J_{sub} of reference points. Curve sampling module 230 transmits the generated dense trajectories to Bézier Motion Module (BMM) 240.

In various embodiments, BMM 240 includes a generative diffusion machine learning model incorporating a transformer encoder architecture. The choice of a transformer encoder architecture is not intended to limit the scope of the invention, and BMM 240 may include alternate architectures, such as Unets including one-dimensional (1D) convolutions. BMM 240 generates Bézier control points that define trajectories (or motion curves) for each reference point included in the limited subset J_{sub} of reference points included in the generic 3D character model. BMM 240 may also be conditioned on specified 3D locations of one or more reference points included in one or more specified frames, such that the generated Bézier control points for a particular reference point define a trajectory that, in each of the specified frames, passes through the specified 3D locations associated with the particular reference point.

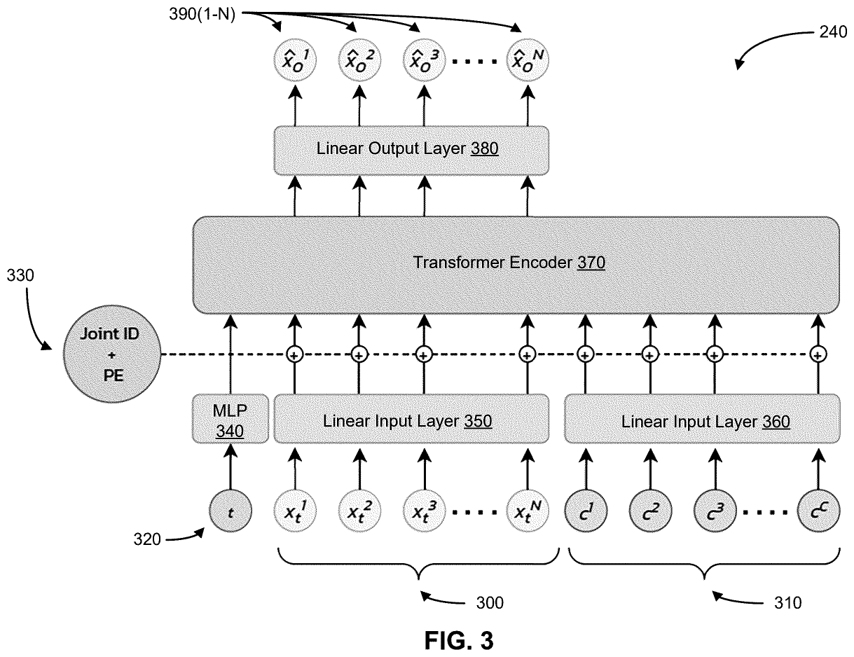

Turning now to FIG. 3, FIG. 3 is a more detailed illustration of Bézier Motion Model (BMM) 240 of FIG. 2, according to some embodiments. BMM 240 maps pure noise to one or more framewise tokens to generate noisy framewise tokens 300. BMM 240 iteratively de-noises noisy framewise tokens 300 over a series of de-noising steps to produce Bézier control points 390(1-N), subject to constraints 310. BMM 240 includes, without limitation, noise step 320, joint ID and positional encoding 330, multilayer perceptron (MLP) 340, linear input layer 350, linear input layer 360, transformer encoder 370, and linear output layer 380.

BMM 240 initializes N framewise tokens

$${x}_{0}^{i} = [ {P}_{j}^{i} , {T}_{j}^{i} , {O}_{j}^{i} \vert j ∈ {J}_{s u b} ]$$

associated with the subset J_{sub} of reference points over a sequence of frames i∈1, . . . , N. N is the number of frames in a window of animation frames, where the window of animation frames begins and ends with designated keyframes.

$${P}_{j}^{i} , {T}_{j}^{i} , and {O}_{j}^{i}$$

represent position, tangent, and orientation trajectories respectively for Bézier curves associated with each reference point in the subset J_{sub} of reference points. Training engine 122 N maps pure noise onto the N framewise tokens based on the current noise step 320 (t) to generate noisy framewise tokens 300

$${x}_{t}^{i} = [ {P}_{j}^{i} , {T}_{j}^{i} , {O}_{j}^{i} \vert i ∈ {J}_{s u b} ]$$

with i∈1, . . . , N. Training engine 122 transmits noisy framewise tokens 300 to transformer encoder 370 via linear input layer 350.

BMM 240 also receives constraints 310, where each of constraints 310 includes a target reference point position for a reference point included in J_{sub}. Each of constraints 310 is associated with a particular frame included in the sequence of frames, such that each of constraints 310 specifies a location for a particular reference point in a particular frame. Training engine 122 transmits constraints 310 to transformer encoder 370 via linear input layer 360.

Training Engine 122 transmits the current noise step 320 (t) to transformer encoder 370 via multilayer perceptron (MLP) 340. Training engine 122 also transmits joint identifier and positional encoding (joint ID+PE) 330 to BMM 240. Joint ID+PE 330 includes a joint identifier that specifies a particular reference point included in J_{sub} via a one-hot vector and a positional encoding that specifies a particular frame i∈1, . . . , N. Joint ID+PE 330 enables transformer encoder 370 to associate the constraints with the trajectories of the different reference points in J_{sub}, while the positional encoding PE preserves the temporal ordering of the multiple animation frames. Training engine 122 combines the Joint ID+PE 330 with noisy framewise tokens 300 and constraints 310, such that each of noisy framewise tokens 300 is associated with its corresponding frame and each constraint included in constraints 310 is associated with a particular reference point included in J_{sub} and a particular frame included in the animation sequence.

Transformer encoder 370 denoises noisy framewise tokens 300 based on the current noise step 320 (t) and one or more adjustable internal weights included in transformer encoder 370. After a predetermined number of noise steps, transformer encoder 370 generates Bézier control points 390(1-N) via linear output layer 380. Each of Bézier control points 390(1-N) is associated with a specific frame i∈1, . . . , N and includes position, tangent, and orientation values associated with one of the reference points included in J_{sub} and associated with the specific frame i. The generated Bézier control points 390(1-N) define Bézier curves associated with each of the reference points included in J_{sub}, subject to constraints 310.

Returning now to FIG. 2, training engine 122 generates trajectories 250 based on Bézier control points 390(1-N) generated by BMM 240. For each frame included in a window of N frames, each of trajectories 250 includes predicted per-frame positions and orientations for one of the reference points included in J_{sub}. Training engine 122 evaluates generated trajectories 250 based on loss functions 260.

Loss functions 260 include multiple L2 loss functions that compare the predicted per-frame reference point positions and orientations against ground truth reference point positions and orientations included in the Bézier curves generated by Bézier fitting module 220 described above. Loss functions 260 also include an additional L2 loss function to compare the predicted per-frame reference point positions with reference point positions included in constraints 310:

$${ℒ}_{c} = {‖ C ⊗ ( P - \hat{P} ) ‖}_{2}$$

where C is a binary constraints mask identifying which constraints are present and ⊗ is element-wise multiplication.

Additionally, training engine 122 may generate dense positions \hat{P}_{d} by sampling the Bézier curves defined by control points 390(1-N) using Equation (1). Loss functions 260 estimate velocities \hat{V} based on finite differences on \hat{P}_{d} and calculate dense position and velocity losses against ground truth P_{d} and V_{d} values calculated based on the dense trajectories generated by curve sampling module 230 described above.

Based on the loss values calculated by loss functions 260, training engine 122 modifies the one or more adjustable internal weights included in transformer encoder 370 described in FIG. 3. Training engine 122 may iteratively modify the one or more adjustable internal weights based on additional animation sequences included in training samples 200. Training engine 122 may continue to iteratively modify the one or more adjustable internal weights for a predetermined number of iterations, or until the loss values calculated by loss functions 260 are below one or more predetermined thresholds.

Training engine 122 generates trained BMM 270, where trained BMM 270 includes the one or more adjustable weights included in transformer encoder 370 modified as described above based on loss functions 260. Training engine 122 transmits trained BMM 270 to inference engine 124.

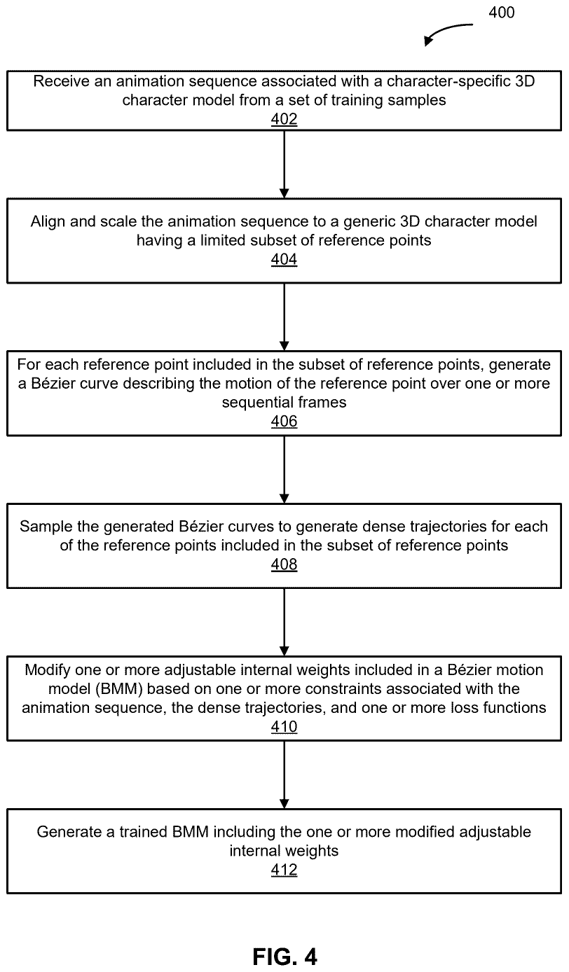

FIG. 4 is a flow diagram of method steps for training Bézier Motion Model 240, according to some embodiments. Although the method steps are described in conjunction with the systems of FIGS. 1-2, persons skilled in the art will understand that any system configured to perform the method steps in any order falls within the scope of the present disclosure.

As shown, in step 402 of method 400, training engine 122 receives an animation sequence included in training samples 200. The animation sequence includes multiple frames depicting one of multiple character-specific 3D character models. Each of the multiple character-specific 3D character models may include an arbitrary number of reference points associated with features of the 3D character model, such as bones or joints. In various embodiments, each of the multiple character-specific 3D character models may exhibit a generally humanoid appearance, such that the character-specific 3D character model includes reference points substantially corresponding to at least a head, left and right hands, left and right feet, and hips included in a 3D character. In some embodiments, a single reference point representing both hips included in the 3D character may be located substantially at the geometric center of the 3D character's pelvis.

Each of multiple frames included in the animation sequence depicts 3D positions and/or orientations of multiple reference points associated with the character-specific 3D character model. Each of the multiple frames also includes a sequential frame number, such that the multiple frames, when viewed in an order specified by the sequential frame numbers, depict motion of the 3D character model over time.

In step 404, alignment/scaling module 210 of training engine 122 adjusts the shape and size of the character-specific 3D character model included in the animation sequence received from training samples 200 to align the character-specific 3D character model to a generic 3D character model. In various embodiments, the generic 3D character model may include a limited subset J_{sub} of reference points representing bones, joints, or other features of the generic 3D character. For example, the generic 3D character model may include six reference points representing a head, left hand, right hand, left foot, right foot, and a single hip reference point. Alignment/scaling module 210 may scale or otherwise transform the character-specific 3D character model included in the animation sequence received from training samples 200, such that positions of reference points included in the training sample animation sequence corresponding to the limited subset J_{sub} of reference points align with the positions of the limited subset J_{sub} of reference points included in the generic 3D character model. For each frame of an animation sequence included in training samples 200, alignment/scaling module 210 generates a corresponding frame depicting the generic 3D character model, where the positions and/or orientations of the limited subset J_{sub} of reference points included in the generic 3D character model are based on the positions and/or orientations of corresponding reference points included in the character-specific 3D character model.

Alignment/scaling module 210 may also identify one or more keyframes associated with a generic 3D character model animation sequence generated by alignment/scaling module 210. In various embodiments, alignment/scaling module 210 may designate every Nth frame of an animation sequence as a keyframe, where N is equal to, e.g., six. For each designated keyframe, alignment/scaling module 210 records the positions and orientations of each of the limited subset J_{sub} of reference points included in the generic 3D character model and depicted in the frame.

In step 406, Bézier fitting module 220 of training engine 122 generates a Bézier curve associated with each of the reference points included in the limited subset of reference points J_{sub} describing the motion of the reference point beginning at one keyframe and ending at the subsequent keyframe. A Bézier curve includes a parametric function that is operable to perform smooth interpolation between two points based on an approximation of a continuous function.

In various embodiments, each of the Bézier curves may include a cubic Bézier curve (i.e. a curve having a degree n=3) defined by four points. Equivalently, a cubic Bézier curve may be defined by a starting point, an ending point, and tangents associated with each of the starting and ending points. Other embodiments of the present invention may include Bézier curves having a different degree n, or may employ parametric curves other than Bézier curves.

For a portion of a received generic 3D character animation sequence including at least two keyframes, Bézier fitting module 220 generates a Bézier curve for each reference point included in the animation sequence, where the Bézier curve describes the motion and orientation of the reference point in the 3D coordinate system from the starting keyframe to the subsequent engine keyframe. Bézier fitting module 220 may continue generating additional Bézier curves associated with each reference point, taking the most recent ending keyframe as a new starting keyframe and selecting a subsequent keyframe in the animation sequence as a new ending keyframe. Bézier fitting module 220 may continue processing the received generic 3D character animation sequence until Bézier fitting module 220 has generated Bézier curves describing the motion of each of the limited subset J_{sub} of reference points throughout the animation sequence.

In step 408, curve sampling module 230 of training engine 122 samples the Bézier curves generates by Bézier fitting module 220 to generate dense trajectories associated with each of the reference points included in the subset J_{sub} of reference points. A dense trajectory associated with a reference point may include an associated position and an associated orientation for the associated reference point at each frame included in a window, where the window includes animation frames located between a starting keyframe and an ending keyframe.

In step 410, training engine 122 modifies one or more adjustable internal weights included in Bézier Motion Model (BMM) 240. BMM 240 takes as input a set of noisy framewise tokens 300 and a set of constraints 310. Each constraint included in constraints 310 defines a position associated with a particular reference point included in J_{sub} at a particular frame number i∈1, . . . , N, where N is the number of frames in the animation sequence.

In various embodiments, BMM 240 includes a generative diffusion machine learning model incorporating a transformer encoder 370. Transformer encoder 370 includes one or more adjustable internal weights that guide the operation of transformer encoder 370. BMM 240 generates Bézier control points 390(1-N) that define trajectories (or motion curves) for each reference point included in the limited subset J_{sub} of reference points across N sequential frames. BMM 240 may also be conditioned on specified 3D locations of one or more reference points included in one or more specified frames, such that the generated Bézier control points for a particular reference point define a trajectory that, in each of the specified frames, passes through the specified 3D locations associated with the particular reference point.

Loss functions 260 include multiple L2 loss functions that compare the predicted per-frame reference point positions and orientations against ground truth reference point positions and orientations included in the Bézier curves generated by Bézier fitting module 220 described above. Loss functions 260 also include an additional L2 loss function to compare the predicted per-frame reference point positions with reference point positions included in constraints 310:

$${ℒ}_{c} = {‖ C ⊗ ( P - \hat{P} ) ‖}_{2} \qquad ( 2 )$$

where C is a binary constraints mask identifying which constraints are present and ⊗ is element-wise multiplication.

Additionally, training engine 122 may generate dense positions \hat{P}_{d} by sampling the Bézier curves defined by control points 390(1-N) using Equation (1). Loss functions 260 estimate velocities \hat{V} based on finite differences on \hat{P}_{d} and calculate dense position and velocity losses against ground truth P_{d} and V_{d} values calculated based on the dense trajectories generated by curve sampling module 230 described above.

Based on the loss values calculated by loss functions 260, training engine 122 modifies the one or more adjustable internal weights included in transformer encoder 370 described in FIG. 3. Training engine 122 may iteratively modify the one or more adjustable internal weights based on additional animation sequences included in training samples 200. Training engine 122 may continue to iteratively modify the one or more adjustable internal weights for a predetermined number of iterations, or until the loss values calculated by loss functions 260 are below one or more predetermined thresholds.

In step 412, training engine 122 generates trained BMM 270 including the one or more modified adjustable internal weights. Trained BMM 270 generates trajectories associated with one or more reference points included in a generic 3D character model, given one or more spatial constraints associated with the one or more reference points. Training engine 122 transmits trained BMM 270 to inference engine 124 described below.

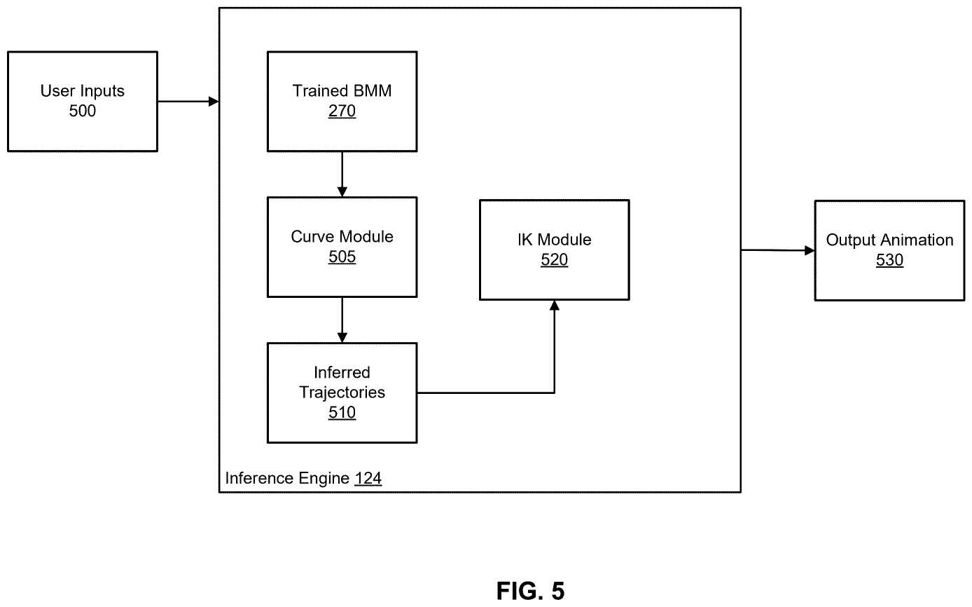

FIG. 5 is a more detailed illustration of inference engine 124 of FIG. 1, according to some embodiments. Inference engine 124 receives user input 500 including one or more framewise spatial constraints. User input 500 may also include a designation of a character-specific 3D character model. Inference engine 124 generates output animation 530 including multiple animation frames depicting the motion of the designated character-specific 3D character model included in user input 500, subject to the one or more framewise spatial constraints included in user input 500. Inference engine 124 includes, without limitation, trained Bézier Motion Model (BMM) 270, curve module 505, inferred trajectories 510, and Inverse Kinematics (IK) module 520.

User input 500 includes one or more framewise spatial constraints associated with a generic 3D character model having a limited subset J_{sub} of reference points. As discussed above, the limited subset J_{sub} of reference points may include six reference points representing a head, left and right hands, left and right feet, and hips included in the generic 3D character model. Each of the one or more framewise spatial constraints may include a specified position for one of the reference points included in J_{sub} during a specified animation frame. For example, the one or more framewise spatial constraints may specify positions associated with each reference point included in J_{sub} for a beginning animation frame, as well as positions associated with each reference point included in J_{sub} for an ending animation frame.

User inputs 500 may also include a designation specifying a character-specific 3D character model. A character-specific 3D character model may include an arbitrary number of reference points representing joints, bones, or other features included in the character-specific 3D character model. In various embodiments, the character-specific 3D character model may exhibit a generally humanoid appearance, such that the character-specific 3D character model includes reference points substantially corresponding to at least the subset of reference points included in J_{sub}, e.g., a head, left and right hands, left and right feet, and hips included in a 3D character. Inference engine 124 receives the one or more spatial constraints included in user inputs 500 and transmits the spatial constraints to trained Bézier Motion Model (BMM) 270. Inference engine 124 also receives the character-specific 3D character model designation included in user inputs 500 and transmits the character-specific 3D character model designation to IK module 520.

Trained BMM 270 includes a generative diffusion machine learning model incorporating a transformer encoder architecture substantially similar to BMM 240 discussed above in the description of FIG. 2. Trained BMM 270 further includes the same one or more adjustable internal weights as BMM 240, previously modified by training engine 122 as discussed above.

Trained BMM 270 generates one or more Bézier control points in a similar manner as described above in reference to BMM 240. The one or more Bézier control points specify framewise locations, tangents, or orientations associated with each of the generic 3D character model reference points included in J_{sub}. Trained BMM 270 transmits the one or more Bézier control points to curve module 505.

Curve module 505 calculates Bézier curves associated with each of the generic 3D character model reference points included in J_{sub}, based on the one or more Bézier control points generated by trained BMM 270. Similar to the operation of Bézier fitting module 220 discussed above, each of the Bézier curves may include a cubic Bézier curve (i.e. a curve having a degree n=3) defined by four points. Equivalently, a cubic Bézier curve may be defined by a starting point, an ending point, and tangents associated with each of the starting and ending points.

Curve module 505 samples the calculated Bézier curves at multiple locations between the Bézier control points generated by trained BMM 270. Each of the sampled values represents a position of a reference point associated with the generic 3D character model and included in the subset J_{sub} of reference points. In various embodiments, curve module 505 may sample the calculated Bézier curves according to Equation (1) above.

Based on the sampled Bézier curve values and the reference point positions included in the one or more Bézier control points generated by trained BMM 270, inference engine 124 generates inferred trajectories 510. Each of inferred trajectories 510 describes the motion of a reference point included in the subset J_{sub} of reference points as a series of framewise positions of the reference point. Inference engine 124 may also calculate an orientation value corresponding to each sampled curve value via linear interpolation on orientation values associated with the Bézier control points generated by trained BMM 270. Inferred trajectories 510 collectively describe animated motion associated with the generic 3D character model over a series of frames. Inference engine transmits inferred trajectories 510 to Inverse Kinematics (IK) module 520.

In various embodiments, IK module 520 includes a pre-trained Inverse Kinematics (IK) machine learning model operable to generate a set of positions associated with multiple reference points included in a character-specific 3D character model, based on inferred trajectories 510 associated with reference points associated with the generic 3D character model and included in the subset J_{sub} of reference points. The operation of IK module 520 is tailored to a specific 3D character model, where the specific 3D character model may include an arbitrary number of reference points greater than or equal to the number of generic 3D character model reference points included in J_{sub}. In various embodiments, inference engine 124 may include multiple instances of IK module 520, where each instance of IK module 520 is tailored to a different character-specific 3D character model. In these embodiments, inference engine 124 may select an appropriate instance of IK module 520 based on the character-specific 3D character model designation included in user inputs 500. In other embodiments, inference engine 124 may include a single instance of IK module 520. In these embodiments, inference engine 124 may adjust one or more internal weights included in IK module 520 based on the character-specific 3D character model designation included in user inputs 500 and previously determined internal weight values associated with the character-specific 3D character model stored in and retrieved from, e, storage 114. In other words, in embodiments of the present invention that include a single instance of IK module 520, inference engine 124 may reconfigure IK module 520 at inference time, such that IK module 520 is operable to generate framewise positions for reference points included in the character-specific 3D character model designated in user inputs 500. The recitation of a framewise IK machine learning model is not intended to limit the scope of the present invention, and the disclosed techniques may include other IK models, including a different learned framewise IK model, a temporal model, a temporal diffusion model, or a traditional IK rig.

IK module 520 transfers each of inferred trajectories 510 from the generic 3D character reference point included in J_{sub}, e.g., head, hands, feet, or hips, to a corresponding reference point included in the character-specific 3D character model associated with IK module 520. IK module 520 generates trajectories for different reference points included in the character-specific 3D character model via any suitable inverse kinematics techniques, based on hierarchical relationships between reference points included in the character-specific 3D character model. For example, IK module 520 may transfer a generated trajectory associate with the left hand of the generic 3D character model to a reference point associated with a left hand included in the character-specific 3D character model. IK module 520 may then generate trajectories for a left wrist, left elbow, and left shoulder via inverse kinematics techniques based on a hierarchical relationship between the left hand, left wrist, left elbow, and left shoulder included in the character-specific 3D character model. IK module 520 continues transferring inferred trajectories 510 to corresponding reference points in the character-specific 3D character model and generating trajectories for additional reference points included in the character-specific 3D character model until each reference point included in the character-specific 3D character model includes an associated trajectory.

Each of the transferred or generated trajectories includes framewise positions and orientations associated with a reference point included in the character-specific 3D character model, such that the transferred and/or generated trajectories collectively represent motion of the character-specific 3D character model over a sequence of animation frames. Inference engine 124 generates output animation 530 based on the transferred and/or generated trajectories associated with the reference points included in the character-specific 3D character model.

Output animation 530 represents the motion of the character-specific 3D character model, subject to the spatial constraints included in user inputs 500. Because inferred trajectories 510 that determine the movement of individual reference points included in the character-specific 3D character model are based on Bézier curves calculated by curve module 505 as described above, a user may easily modify the generated Bézier curves (and therefore, output animation 530) via traditional 3D animation authoring tools.

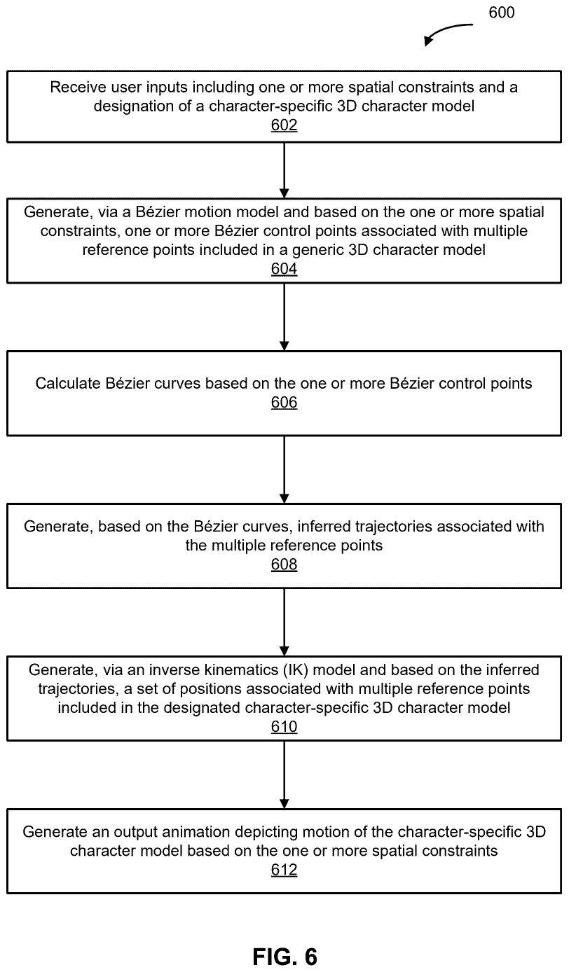

FIG. 6 is a flow diagram of method steps for inferring 3D character model motion, according to some embodiments. Although the method steps are described in conjunction with the systems of FIGS. 1-2 and 5, and persons skilled in the art will understand that any system configured to perform the method steps in any order falls within the scope of the present disclosure.

As shown, in step 602 of method 600, inference engine 124 receives user input 500 including one or more framewise spatial constraints associated with a generic 3D character model having a limited subset J_{sub} of reference points. As discussed above, the limited subset J_{sub} of reference points may include six reference points representing a head, left and right hands, left and right feet, and hips included in the generic 3D character model. Each of the one or more framewise spatial constraints may include a specified position for one of the reference points included in J_{sub} during a specified animation frame. For example, the one or more framewise spatial constraints may specify positions associated with each reference point included in J_{sub} for a beginning animation frame, as well as positions associated with each reference point included in J_{sub} for an ending animation frame.

User inputs 500 may also include a designation specifying a character-specific 3D character model. A character-specific 3D character model may include an arbitrary number of reference points representing joints, bones, or other features included in the character-specific 3D character model. In various embodiments, the character-specific 3D character model may exhibit a generally humanoid appearance, such that the character-specific 3D character model includes reference points substantially corresponding to at least the subset of reference points included in J_{sub}, e.g., a head, left and right hands, left and right feet, and hips included in a 3D character. Inference engine 124 receives the one or more spatial constraints included in user inputs 500 and transmits the spatial constraints to trained Bézier Motion Model (BMM) 270. Inference engine 124 also receives the character-specific 3D character model designation included in user inputs 500 and transmits the character-specific 3D character model designation to IK module 520.

In step 604, trained Bézier Motion Model (BMM) 270 of inference engine 124 generates one or more Bézier control points associated with the subset J_{sub} of reference points included in the generic 3D character model. BMM 270 includes a generative diffusion machine learning model incorporating a transformer encoder architecture. The one or more generated Bézier control points specify framewise locations, tangents, and orientations associated with each of the generic 3D character model reference points included in J_{sub}. Trained BMM 270 transmits the one or more Bézier control points to curve module 505.

In step 606, curve module 505 of inference engine 124 calculates Bézier curves associated with each of the generic 3D character model reference points included in J_{sub}, based on the one or more Bézier control points generated by trained BMM 270. Each of the Bézier curves may include a cubic Bézier curve (i.e. a curve having a degree n=3) defined by four points. Equivalently, a cubic Bézier curve may be defined by a starting point, an ending point, and tangents associated with each of the starting and ending points. Each of the calculated Bézier curves describes the motion of a reference point associated with the generic 3D character model and included in the subset J_{sub} of reference points.

In step 608, curve module 505 samples the calculated Bézier curves and generates inferred trajectories 510. Each of inferred trajectories 510 describes the motion of a reference point included in the subset J_{sub} of reference points as a series of framewise positions of the reference point. Inference engine 124 may also calculate an orientation value corresponding to each sampled curve value via linear interpolation on orientation values associated with the Bézier control points generated by trained BMM 270. Inferred trajectories 510 collectively describe animated motion associated with the generic 3D character model over a series of frames. Inference engine transmits inferred trajectories 510 to Inverse Kinematics (IK) module 520.

In step 610, IK module 520 of inference engine 124 generates a set of framewise positions associated with multiple reference points included in a character-specific 3D character model, based on inferred trajectories 510 associated with reference points associated with the generic 3D character model and included in the subset J_{sub} of reference points. The operation of IK module 520 is tailored to a specific 3D character model, where the specific 3D character model may include an arbitrary number of reference points greater than or equal to the number of generic 3D character model reference points included in J_{sub}.

IK module 520 transfers each of inferred trajectories 510 from the generic 3D character reference point included in J_{sub}, e.g., head, hands, feet, or hips, to a corresponding reference point included in the character-specific 3D character model associated with IK module 520. IK module 520 generates trajectories for different reference points included in the character-specific 3D character model via any suitable inverse kinematics techniques, based on hierarchical relationships between reference points included in the character-specific 3D character model. For example, IK module 520 may transfer a generated trajectory associate with the left hand of the generic 3D character model to a reference point associated with a left hand included in the character-specific 3D character model. IK module 520 may then generate trajectories for a left wrist, left elbow, and left shoulder via inverse kinematics techniques based on a hierarchical relationship between the left hand, left wrist, left elbow, and left shoulder included in the character-specific 3D character model. IK module 520 continues transferring inferred trajectories 510 to corresponding reference points in the character-specific 3D character model and generating trajectories for additional reference points included in the character-specific 3D character model until each reference point included in the character-specific 3D character model has an associated trajectory. Each of the transferred or generated trajectories includes framewise positions and orientations associate with a reference point included in the character-specific 3D character model, such that the transferred and/or generated trajectories represent motion of the character-specific 3D character model over a sequence of animation frames.

In step 612, inference engine 124 generates output animation 530 based on the transferred and/or generated trajectories associated with the reference points included in the character-specific 3D character model. Output animation 530 represents the motion of the character-specific 3D character model designated in user inputs 500, subject to the spatial constraints included in user inputs 500.

In sum, the disclosed techniques generate an animation sequence for a specific 3D animation character model. The disclosed techniques include training a Bézier Motion Model (BMM) to generate positions and orientations over time for a limited set of joints or other reference points in a generic 3D character model, given a set of constraints including time-specific reference point positions. For example, the BMM may predict time-varying positions and orientations for reference points representing the generic 3D character model's head, hands, hips, and feet. The time varying positions generated for each reference point may be expressed as points or tangents included in a cubic Bézier curve, with each point on the curve having an associated orientation for the corresponding reference point. The disclosed techniques calculate dense trajectories for each of the limited set of reference points, where the dense trajectories include time-varying positions and orientations for each reference point in the limited set of reference points. The disclosed techniques process the calculated dense trajectories via a trained character-specific Inverse Kinematics (IK) module. For each frame of an output animation, the IK module generates position and orientation values for each reference point included in the specific 3D character model. The output animation depicts the motion of the specific 3D character model, subject to the time-varying reference point position constraints supplied as input to the BMM.

In operation, a training engine trains a Bézier Motion Model (BMM) to generate trajectories for a limited number of reference points included in a generic 3D character model. For example, reference points may include a head, hands, feet, and hips, and the trajectories may include positions and orientations for each of the reference points over a number of sequential frames.

The training engine receives a number of training samples, where the training samples include animation sequences depicting one of one or more character-specific 3D models. Each of the character-specific 3D models may represent a different character and include an arbitrary number of reference points, i.e., a character model included in the training samples may include more reference points than the hands, feet, head, and hips include in the generic 3D character model. The training engine aligns and scales each of the character-specific 3D character models included in the training samples to a generic 3D character model having a limited number of reference points as described above. For each animation sequence included in the training samples, the training engine generates a Bézier curve associated with each reference point describing the trajectory of the reference point over time. The training engine samples reference point positions every Nth frame of the animation sequence, e, every sixth frame, to generate spatial constraints associated each reference point included in the generic 3D character model.

The training engine transmits the generated reference point trajectories and spatial constraints to the BMM, as well as a one-hot vector indicating which reference point a trajectory is associated with and a positional encoding representing a particular animation frame associated with the input. The BMM generates output Bézier control points representing trajectories for each of the reference points over time. The training engine iteratively modifies one or more values associated with the BMM based on loss functions that calculate differences between reference point positions, orientations, and velocities generated by the BMM and corresponding ground truth values calculated from the training samples. The trained BMM is operable to receive reference point spatial constraints associated with a beginning animation frame and an ending animation frame, and generate Bézier curves for each of the reference points describing the points' trajectories for animation frames between the beginning and ending animation frames.

At inference time, an inference engine receives frame-specific spatial constraints associated with the limited number of reference points included in the generic 3D character model. Via the trained BMM, the inference engine generates Bézier control points representing the trajectories of the limited number of reference points over one or more frames between the beginning and ending frames. The inference engine calculates Bézier curves based on the Bézier control points. The inference engine samples the calculated Bézier curves at multiple points to generate dense trajectory values for each of the limited number of reference points, where each trajectory includes both positions and orientations over time for an associated reference point.

The inference engine transmits the generated dense trajectory values to a character-specific, pre-trained Inverse Kinematics (IK) module. The IK module maps the dense trajectory values associated with the limited number of reference points included in the generic 3D character model to framewise positions for a potentially greater number of reference points included in the character-specific 3D character model. Based on the mappings, the inference engine generates an output animation depicting the character-specific 3D character model in motion subject to the specified spatial constraints.

One technical advantage of the disclosed techniques relative to the prior art is that the disclosed techniques infer motion sequences for a specific 3D character model via both a character-agnostic 3D motion model and a character-specific 3D character model. The character-agnostic motion model includes a limited number of bones, joints, or other reference points, and may be trained on a relatively large quantity of motion sequences captured from a variety of different 3D animation characters. The character-specific character model, in contrast, requires a relatively small amount of character-specific training data. The use of both character-agnostic and character-specific models allows the disclosed techniques to generate motion sequences for a variety of character-specific 3D character models, including 3D character models for which only a limited amount of training data is available. The disclosed techniques also infer character movements over time by expressing the motion of joints or other reference points as Bézier curves. Bézier curves are compatible with traditional 3D animation authoring tools, and allow for simple corrections to reference point positions in an inferred motion sequence. These technical advantages provide one or more improvements over prior art approaches.

1. In some embodiments, a computer-implemented method for animating a three-dimensional (3D) character model, the computer-implemented method comprises receiving one or more spatial constraints associated with a first set of one or more reference points included in a first 3D character model, generating, via a first machine learning model and based on the one or more spatial constraints, a set of trajectories associated with each reference point included in the first set of one or more reference points, generating, via a second machine learning model and based on the set of trajectories, a set of framewise positions associated with a second set of one or more reference points included in a second 3D character model, and generating an output animation depicting motion of the second 3D character model based on the set of framewise positions.

2. The computer-implemented method of clause 1, wherein the second set of one or more reference points includes a greater number of reference points than the first set of one or more reference points.

3. The computer-implemented method of clauses 1 or 2, wherein the first machine learning model includes a generative diffusion machine learning model incorporating a transformer encoder architecture.

4. The computer-implemented method of any of clauses 1-3, wherein the first machine learning model generates one or more Bézier control points defining a Bézier curve describing the motion of a reference point included in the first set of reference points.

5. The computer-implemented method of any of clauses 1-4, wherein each trajectory included in the set of trajectories is generated based on multiple samples evaluated at multiple points included in the Bézier curve.

6. The computer-implemented method of any of clauses 1-5, wherein the second machine learning model includes an inverse kinematics (IK) model.

7. The computer-implemented method of any of clauses 1-6, further comprising associating each of the one or more reference points included in the first set of one or more reference points with a reference point included in the second set of one or more reference points.

8. The computer-implemented method of any of clauses 1-7, wherein each of the one or more spatial constraints includes at least a position associated with a reference point included in the first set of one or more reference points.

9. The computer-implemented method of any of clauses 1-8, wherein the first set of reference points includes reference points associated with one or more of a head, hands, feet, or hips included in the first 3D character model.

10. In some embodiments, one or more non-transitory computer-readable media store instructions that, when executed by one or more processors, cause the one or more processors to perform the steps of receiving one or more spatial constraints associated with a first set of one or more reference points included in a first 3D character model, generating, via a first machine learning model and based on the one or more spatial constraints, a set of trajectories associated with each reference point included in the first set of one or more reference points, generating, via a second machine learning model and based on the set of trajectories, a set of framewise positions associated with a second set of one or more reference points included in a second 3D character model, and generating an output animation depicting motion of the second 3D character model based on the set of framewise positions.

11. The one or more non-transitory computer-readable media of clause 10, wherein the second set of one or more reference points includes a greater number of reference points than the first set of one or more reference points.

12. The one or more non-transitory computer-readable media of clauses 10 or 11, wherein the first machine learning model includes a generative diffusion machine learning model incorporating a transformer encoder architecture.

13. The one or more non-transitory computer-readable media of any of clauses 10-12, wherein the first machine learning model generates one or more Bézier control points defining a Bézier curve describing the motion of a reference point included in the first set of reference points.

14. The one or more non-transitory computer-readable media of any of clauses 10-13, wherein each trajectory included in the set of trajectories is generated based on multiple samples evaluated at multiple points included in the Bézier curve.

15. The one or more non-transitory computer-readable media of any of clauses 10-14, wherein the second machine learning model includes an inverse kinematics (IK) model.

16. The one or more non-transitory computer-readable media of any of clauses 10-15, further comprising associating each of the one or more reference points included in the first set of one or more reference points with a reference point included in the second set of one or more reference points.

17. The one or more non-transitory computer-readable media of any of clauses 10-16, wherein each of the one or more spatial constraints includes at least a position associated with a reference point included in the first set of one or more reference points.

18. The one or more non-transitory computer-readable media of any of clauses 10-17, wherein the first set of reference points includes reference points associated with one or more of a head, hands, feet, or hips included in the first 3D character model.

19. In some embodiments, a system comprises one or more memories storing instructions, and one or more processors for executing the instructions to receive one or more spatial constraints associated with a first set of one or more reference points included in a first 3D character model, generate, via a first machine learning model and based on the one or more spatial constraints, a set of trajectories associated with each reference point included in the first set of one or more reference points, generate, via a second machine learning model and based on the set of trajectories, a set of framewise positions associated with a second set of one or more reference points included in a second 3D character model, and generate an output animation depicting motion of the second 3D character model based on the set of framewise positions.

20. The system of clause 19, wherein the instructions further cause the one or more processors to associate each of the one or more reference points included in the first set of one or more reference points with a reference point included in the second set of one or more reference points.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for animating a three-dimensional (3D) character model, the computer-implemented method comprising:
receiving one or more spatial constraints associated with a first set of one or more reference points included in a first 3D character model;
generating, via a first machine learning model and based on the one or more spatial constraints, a set of trajectories associated with each reference point included in the first set of one or more reference points;
generating, via a second machine learning model and based on the set of trajectories, a set of framewise positions associated with a second set of one or more reference points included in a second 3D character model; and
generating an output animation depicting motion of the second 3D character model based on the set of framewise positions.

2. The computer-implemented method of claim 1, wherein the second set of one or more reference points includes a greater number of reference points than the first set of one or more reference points.

3. The computer-implemented method of claim 1, wherein the first machine learning model includes a generative diffusion machine learning model incorporating a transformer encoder architecture.

4. The computer-implemented method of claim 1, wherein the first machine learning model generates one or more Bézier control points defining a Bézier curve describing the motion of a reference point included in the first set of reference points.

5. The computer-implemented method of claim 4, wherein each trajectory included in the set of trajectories is generated based on multiple samples evaluated at multiple points included in the Bézier curve.

6. The computer-implemented method of claim 1, wherein the second machine learning model includes an inverse kinematics (IK) model.

7. The computer-implemented method of claim 1, further comprising associating each of the one or more reference points included in the first set of one or more reference points with a reference point included in the second set of one or more reference points.

8. The computer-implemented method of claim 1, wherein each of the one or more spatial constraints includes at least a position associated with a reference point included in the first set of one or more reference points.

9. The computer-implemented method of claim 1, wherein the first set of reference points includes reference points associated with one or more of a head, hands, feet, or hips included in the first 3D character model.

10. One or more non-transitory computer-readable media storing instructions that, when executed by one or more processors, cause the one or more processors to perform the steps of:
receiving one or more spatial constraints associated with a first set of one or more reference points included in a first 3D character model;
generating, via a first machine learning model and based on the one or more spatial constraints, a set of trajectories associated with each reference point included in the first set of one or more reference points;
generating, via a second machine learning model and based on the set of trajectories, a set of framewise positions associated with a second set of one or more reference points included in a second 3D character model; and
generating an output animation depicting motion of the second 3D character model based on the set of framewise positions.

11. The one or more non-transitory computer-readable media of claim 10, wherein the second set of one or more reference points includes a greater number of reference points than the first set of one or more reference points.

12. The one or more non-transitory computer-readable media of claim 10, wherein the first machine learning model includes a generative diffusion machine learning model incorporating a transformer encoder architecture.

13. The one or more non-transitory computer-readable media of claim 10, wherein the first machine learning model generates one or more Bézier control points defining a Bézier curve describing the motion of a reference point included in the first set of reference points.

14. The one or more non-transitory computer-readable media of claim 13, wherein each trajectory included in the set of trajectories is generated based on multiple samples evaluated at multiple points included in the Bézier curve.

15. The one or more non-transitory computer-readable media of claim 10, wherein the second machine learning model includes an inverse kinematics (IK) model.

16. The one or more non-transitory computer-readable media of claim 10, further comprising associating each of the one or more reference points included in the first set of one or more reference points with a reference point included in the second set of one or more reference points.

17. The one or more non-transitory computer-readable media of claim 10, wherein each of the one or more spatial constraints includes at least a position associated with a reference point included in the first set of one or more reference points.

18. The one or more non-transitory computer-readable media of claim 10, wherein the first set of reference points includes reference points associated with one or more of a head, hands, feet, or hips included in the first 3D character model.

19. A system comprising:
one or more memories storing instructions; and
one or more processors for executing the instructions to:
receive one or more spatial constraints associated with a first set of one or more reference points included in a first 3D character model;
generate, via a first machine learning model and based on the one or more spatial constraints, a set of trajectories associated with each reference point included in the first set of one or more reference points;
generate, via a second machine learning model and based on the set of trajectories, a set of framewise positions associated with a second set of one or more reference points included in a second 3D character model; and
generate an output animation depicting motion of the second 3D character model based on the set of framewise positions.

20. The system of claim 19, wherein the instructions further cause the one or more processors to associate each of the one or more reference points included in the first set of one or more reference points with a reference point included in the second set of one or more reference points.
